(19) United States
(12) Patent Application Publication
(10) Pub. No.: US 2026/0222213 A1
(43) Pub. Date: Jul. 30, 2026

(54) SECURE ACCESSORY AUTHENTICATION VIA MULTIFACTOR SIGNALS

(71) Applicant: Google LLC, Mountain View, CA (US)

(72) Inventors: Nicholas Sanders, Saratoga, CA (US); Andrew Felch, Palo Alto, CA (US)

(73) Assignee: Google LLC, Mountain View, CA (US)

(21) Appl. No.: 19/040,060

(22) Filed: Jan. 29, 2025

(51) Int. Cl. H04L 9/32; H04L 9/08

(52) U.S. Cl. CPC H04L 9/3236; H04L 9/0866

(57) ABSTRACT

A docking system may include a dock that stores a dock identifier and an electronic device that docks with the dock. The electronic device can receive the dock identifier, obtain wireless network information, and create a hash value based on the dock identifier and additional information, such as wireless network information. The hash value may be analyzed using a stored hash to identify a match. In response to the match, the system may permit access to a restricted feature while the electronic device remains docked.

### BACKGROUND

Docks for electronic devices are useful and frequently found in homes and offices. A user can place an electronic device, such as a smartphone or tablet computer, onto the dock for storage and charging. While docked with the dock, the user may find it useful for certain features of the dock to be readily available. Such features may typically be restricted, such as the ability to view security camera video feeds. As an example, if a user has smart home devices installed in the house where the dock is located, it may be convenient for controls of the smart home device to be presented while docked. Even if no smart home devices are present, another feature, such as a personal calendar can be presented while docked. Such a feature of providing access to a restricted feature may be beneficial but can present security risks. Embodiments detailed herein address this and other issues, such as how to provide security in a cost-effective manner.

### SUMMARY

In some embodiments, a docking system is presented. The docking system may comprise a dock that includes a non-transitory processor-readable medium. The non-transitory processor-readable medium may store a dock identifier. The docking system may further include an electronic device configured to dock with the dock. The electronic device may be configured to receive the dock identifier from the dock. The electronic device may be configured to obtain wireless network information. The electronic device may be configured to create a hash value based on the dock identifier and the wireless network information. The electronic device may be configured to analyze the hash value using a stored hash to identify a match. The electronic device may, in response to the match, permit access to a restricted feature while the electronic device remains docked with the dock.

Embodiments of such a docking system can include one or more of the following features. Each of these features, unless otherwise noted, can be separately incorporated into an embodiment of the docking system. The dock identifier may be permanently associated with the dock. The electronic device may be further configured to transmit, to a remote server system, a request for one or more stored hashes mapped to the electronic device. The electronic device may, in response to the request, receive the one or more stored hashes from the remote server system. The wireless network information may comprise a service set identifier (SSID) and passkey. The electronic device may be further configured to create the hash value based on a device identifier indicative of an owner and a salt value. The electronic device may be further configured to create an initial hash value using the dock identifier and wireless network information. The electronic device may be further configured to obtain user authorization to allow access to the restricted feature while the electronic device remains docked with the dock. The electronic device may be further configured to create the stored hash based on the initial hash value. The electronic device may be further configured to transmit the stored hash for storage to a remote server system. The docking system may further comprise a remote server system. The remote server system may be configured to store the stored hash received from the electronic device. The remote server system may, in response to storing the stored hash, cause an indication of a device pairing between the dock and the electronic device to be presented in an application. The remote server system may be configured to receive, from the application, a request to remove the device pairing. The remote server system may, in response to receiving the request to remove the device pairing, delete the stored hash. The remote server system may be configured to store a plurality of stored hashes, comprising the stored hash. Each stored hash may be mapped to the electronic device and a different dock.

In some embodiments, an electronic device is presented. The electronic device may comprise a housing and an electronic display housed by the housing. The electronic device may comprise a processing system that includes one or more processors housed by the housing. The processing system may be configured to obtain a dock identifier from the dock when the electronic device is docked with the dock for charging the electronic device. The processing system may be configured to obtain wireless network information. The processing system may be configured to create a hash value based on the dock identifier and the wireless network information. The processing system may be configured to analyze the hash value using a digital certificate to identify a match. The processing system may, in response to the match, permit access to a restricted feature while the electronic device remains docked with the dock.

Embodiments of such an electronic device can include one or more of the following features. Each of these features, unless otherwise noted, can be separately incorporated into an embodiment of the electronic device. The restricted feature may provide control of one or more smart home devices. The dock identifier may be permanently associated with the dock. The electronic device may be further configured to transmit, to a remote server system, a request for one or more stored hashes mapped to the electronic device. The electronic device may, in response to the request, receive the one or more stored hashes from the remote server system. The wireless network information may comprise a service set identifier (SSID) and passkey. The processing system may be further configured to create the hash value based on a device identifier indicative of an owner and a salt value. The processing system may be further configured to create an initial hash value using the dock identifier and wireless network information. The processing system may be further configured to obtain user authorization to allow access to the restricted feature while the electronic device remains docked with the dock. The processing system may be further configured to create the stored hash based on the initial hash value. The processing system may be further configured to transmit the stored hash for storage to a remote server system.

In some embodiments, a method is presented. A method for authenticating an electronic device to provide access to a restricted feature may comprise receiving, by the electronic device, a dock identifier from the dock while the electronic device is docked. The dock identifier may be permanently associated with the dock. The method may comprise obtaining, by the electronic device, wireless network information. The method may comprise creating, by the electronic device, a hash value based on the dock identifier and the wireless network information. The method may comprise analyzing the hash value using a stored hash to identify correspondence between the hash value and the stored hash. The method may, in response to the hash value and the stored hash being determined to correspond, permit access to a restricted feature of the electronic device while the electronic device remains docked with the dock.

Embodiments of such a method can include one or more of the following features. Each of these features, unless otherwise noted, can be separately incorporated into an embodiment of the method. Creating the hash value may further be based on a salt value created locally by the electronic device. The restricted feature may allow for control of one or more smart home devices. The method may further comprise retrieving, by the electronic device, the stored hash value from a remote server system. The stored hash may be stored by the remote server system as mapped to an account associated with the electronic device.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a docking system in which an electronic device is docked with a dock.

FIG. 2 illustrates a block diagram of an embodiment of a docking system.

FIG. 3 illustrates an embodiment of a smart home application.

FIG. 4 illustrates an embodiment of a method for creating pairing between a dock and electronic device.

FIG. 5 illustrates an embodiment of a method for authenticating an electronic device to provide access to a restricted feature when docked.

FIG. 6 illustrates an embodiment of a method for removing a pairing between a dock and an electronic device.

### DETAILED DESCRIPTION

Docks, which can provide charging, are typically placed in relatively secure locations, such as within a home or office. When an electronic device, such as a smartphone, tablet computer, smartwatch, or gaming device, is docked with a dock, a user may desire that one or more features be readily available for use. Some features available on an electronic device may typically be restricted and require a user to unlock the electronic device before use. However, the user may desire that such features be readily available while docked with the dock such that unlocking is not required. As an example, while docked (and, possibly, charging), a device can show a personalized slide show of photos, smart home device controls, a security camera video feed, a personalized calendar, or some other information or controls.

In order to provide access to such restricted features, a determination can be made that the electronic device is docked with a particular dock with which a pairing process has been completed. In order to identify the dock, information is required to be exchanged between the dock and the electronic device. In embodiments detailed herein, the dock can have a stored fixed identifier, such as a serial number. The stored fixed identifier can remain the same for the lifetime of the dock and is not affected by actions such as a dock reset or transfer to another user account. An advantage of having such a fixed identifier is that the complexity of components to maintain a fixed identifier can be reduced compared to an arrangement where the identifier changes under various circumstances. Further, use of a fixed identifier allows for easier compliance across multiple dock manufacturers.

In embodiments detailed herein, the dock can transfer a fixed identifier, which may be encrypted, to a device that is docked with the dock. The device can then create a cryptographic hash involving various pieces of data, such as including: the fixed identifier received from the dock, local wireless network information (e.g., service set identifier (SSID) and passkey), a device identifier, and a salt value. The local wireless network information can help prevent a dock from being relocated to another physical location and unintentionally revealing a restricted feature. For example, if the local wireless network information with which the electronic device is paired matches the local wireless network information used to create the hash, there is a strong likelihood that the dock is relatively close-by to where a user originally configured a pairing between the dock and the electronic device. The created hash can be locally compared with another stored hash that was previously created. This previously-created stored hash can be stored locally by the device or retrieved from a remote server system. If stored by the remote server system, the remote server system may not ever receive the fixed identifier of the dock. Rather, the remote server system only receives a hash created using the fixed identifier.

Based on a comparison between the stored hash value and the hash, the device can determine whether the two hash values match each other. For example, a determination can be made as to whether the hash was created using a set of the same data as the stored hash. If the two hash values match, one or more restricted features of the device can be made available while the device remains docked with the dock. For example, such one or more restricted features may be presented via an idle screen of the device while docked or, when woken from an idle mode, the device may permit access to the one or more restricted features while docked with the dock.

When the device is docked with a different dock, based on differences in the hash value, the device can perform a similar analysis to determine not to provide access to the one or more restricted features. However, another pairing may have been performed such that a different one or more restricted features is provided. For example, different restricted features may be provided when the device is docked at home and at an office.

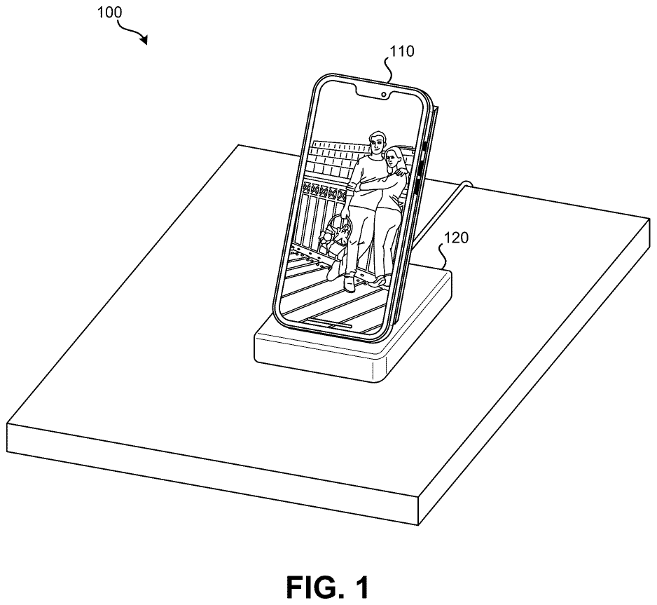

Further details on these and additional embodiments are provided in relation to figures. FIG. 1 illustrates an embodiment of a docking system 100 in which electronic device 110 is docked with dock 120. Dock 120 may include a power cord which is plugged into an outlet. Electronic device 110 can be placed on dock 120, such as to charge. Electronic device 110 can be various forms of electronic devices, such as: a smartphone, a cellular phone, a gaming device, a personal digital assistant, a smartwatch, a tablet computer, a laptop computer, smart home device (e.g., thermostat) or some other form of computerized device. The shape and size of dock 120 can be varied by embodiment to accommodate the one or more types of electronic device that are to be supported. Charging by dock 120 may be accomplished via wired or wireless charging. For example, a magnetic field may be created allowing electronic device 110 to be charged wirelessly.

Electronic device 110 may be considered docked with dock 120 when the electronic device 110 is placed on a surface of dock 120 or inserted, at least partially, into dock 120. Dock 120 may be a cradle or bracketed mount, such as a dashboard board for docking electronic device 110 within a vehicle. For some forms of electronic device 110, a watch stand can serve as dock 120. Dock 120 can be in the form of a pedestal. In some examples, electronic device 110 may be considered docked with dock 120 when the device is charging through a wireless connection or a physical connection, such as a wire, pin connectors, and so on. The same or different wireless or physical connection can be used to transmit data and power to and from electronic device 110 and dock 120, e.g., one connection for power and data, or separate connections for power and data, respectively. In some examples, electronic device 110 may be considered docked with the dock 120 even when power is not being transmitted from the dock 120 to the electronic device 110.

When electronic device 110 is docked with dock 120, access to one or more restricted features is permitted (without further verification, such as via biometrics or a passcode) if the user has previously paired electronic device 110 with dock 120. As illustrated, a user has previously designated a particular photo slideshow for when electronic device 110 is docked with dock 120. Therefore, while docked, electronic device 110 presents images from one or more albums previously designated by the user is presented. Additionally or alternatively, controls for one or more particular device, such as smart home devices, may be presented and may provide access to control such smart home devices without electronic device 110 needing to be unlocked while docked with dock 120.

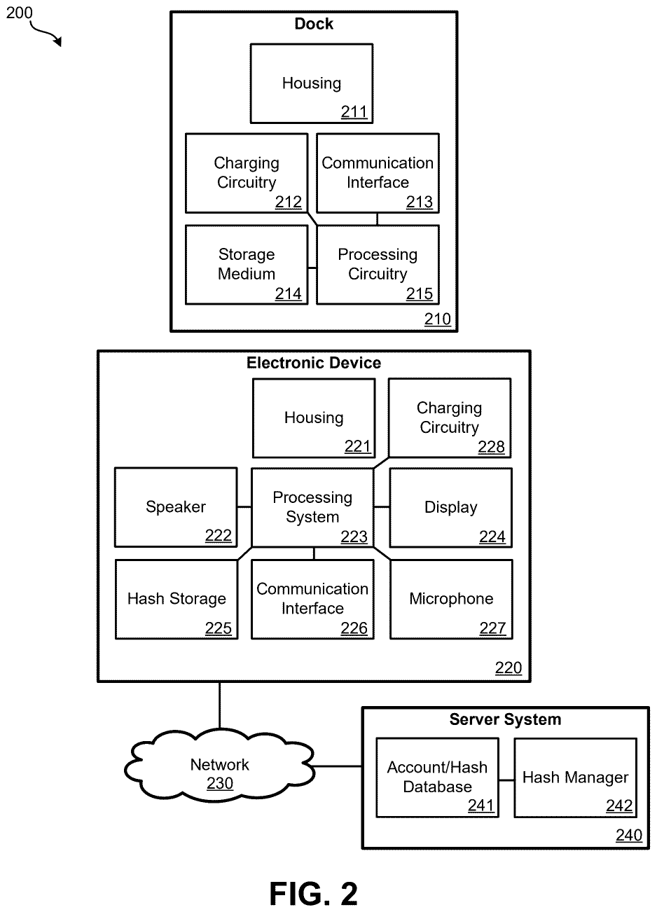

FIG. 2 illustrates a block diagram of an embodiment of a docking system 200. Docking system 200 can represent a block diagram of docking system 100 or another embodiment of a docking system. Docking system 200 can include: dock 210; electronic device 220; network 230; and server system 240. In other embodiments, server system 240 and network 230 may not be present.

Dock 210 can include: housing 211; charging circuitry 212; communication interface 213; storage medium 214; and processing circuitry 215. Housing 211 can be shaped such that electronic device 220 can rest, be placed upon, or otherwise docked with dock 210, such as illustrated in FIG. 1. Housing 211 may incorporate one or more magnets to removably attach dock 210 with electronic device 220. In some embodiments, gravity and friction is used to hold electronic device 220 against dock 210. Housing 211 further serves to house components of dock 210, including charging circuitry 212, communication interface 213, storage medium 214, and processing circuitry 215.

Charging circuitry 212 can provide power to electronic device 220 when electronic device 220 is docked with dock 210. Charging circuitry 212 may use a magnetic field to wirelessly provide power and provide charging to electronic device 220. In other embodiments, one or more electrical contacts may be present that allows for an electrical connection between charging circuitry 212 and charging circuitry of electronic device 220. For example, magnets present in housing 211 may cause pads or pins of charging circuitry 212 to properly align with corresponding pins or pads, respectively, of electronic device 220. When electronic device 220 is docked with dock 210, charging circuitry 212 may provide power. In some embodiments, charging circuitry 212 provides an indication to processing circuitry 215 when charging is occurring or, more generally, when electronic device 220 is docked.

Communication interface 213 allows for communication between dock 210 and electronic device 220. Communication interface 213 may use wired or wireless communication. For example, a short-range device-to-device communication protocol, such as Bluetooth Classic or Bluetooth LE may be used. Other short-range device-to-device communication protocols can include Near Field Communication (NFC) or WiFi® direct. In some embodiments, communication interface 213 can be incorporated with charging circuitry 212 in order to modulate a charging magnetic field frequency and amplitude, thus allowing data to be transmitted to electronic device 220 via the magnetic field produced during wireless charging. In some embodiments, where electrical connections are present between dock 210 and electronic device 220, communication can occur via any proprietary communication protocol or a variety of wired communication protocols.

Storage medium 214 can represent various forms of non-transitory processor-readable mediums. Dock 210 stores a fixed dock identifier. Little to no other data may need to be stored using storage medium 214, therefore very limited data storage is required. Storage medium 214 may also be used to store certificates for encrypted communication with electronic device 220, such as if wireless communication is used. Storage medium and processing circuitry 215 may be incorporated as part of a system on a chip (SOC) component. Processing circuitry 215 may be present in order to coordinate encryption of the fixed dock identifier and transmission of the (encrypted) fixed dock identifier via communication interface 213 when electronic device is docked with dock 210.

“Fixed dock identifier” refers to an identifier, such as a serial number, sufficient to distinguish dock 210 from other docks with which electronic device 220 may be docked. A fixed identifier cannot be changed. Therefore, regardless of the user account that dock 210 is used in combination with or whether any form of soft or hard reset is performed involving dock 210, the fixed dock identifier stored by storage medium 214 remains permanently the same.

Electronic device 220 can represent a variety of computerized devices, such as: a smartphone, a tablet computer, a gaming device, a smartwatch, a personal digital assistant, or some other form of electronic device that can be removably attached with a dock, such as for charging. Electronic device 220 can include: housing 221, speaker 222, processing system 223, display 224, hash storage 225, communication interface 226, microphone 227, and charging circuitry 228. Housing 221 may be shaped to allow electronic device 220 to be removably attached with or placed on housing 211 of dock 210. Housing 221 may incorporate one or more magnets to removably attach electronic device 220 with dock 210. In some embodiments, gravity and friction is used to hold electronic device 220 against dock 210. Housing 221 further houses other components of electronic device 220, such as speaker 222, processing system 223, display 224, hash storage 225, communication interface 226, microphone 227, and charging circuitry 228.

Charging circuitry 228 can obtain power for electronic device 220 when electronic device 220 is docked with dock 210. Charging circuitry 228 may use a magnetic field to wirelessly obtain power and charge one or more on-board batteries of electronic device 220. In other embodiments, one or more electrical contacts may be present that allows for an electrical connection between charging circuitry 228 and charging circuitry 212 of dock 210. For example, magnets present in housing 221 which help align pads or pins of charging circuitry 212 with corresponding pins or pads of housing 221. When electronic device 220 is docked with dock 210, charging circuitry 212 may provide power and charging circuitry 228 can receive the power and charge one or more batteries of electronic device 220 and/or directly power components of electronic device 220. In some embodiments, charging circuitry 228 provides an indication to processing system 223 when charging is occurring or, more generally, when electronic device 220 is docked.

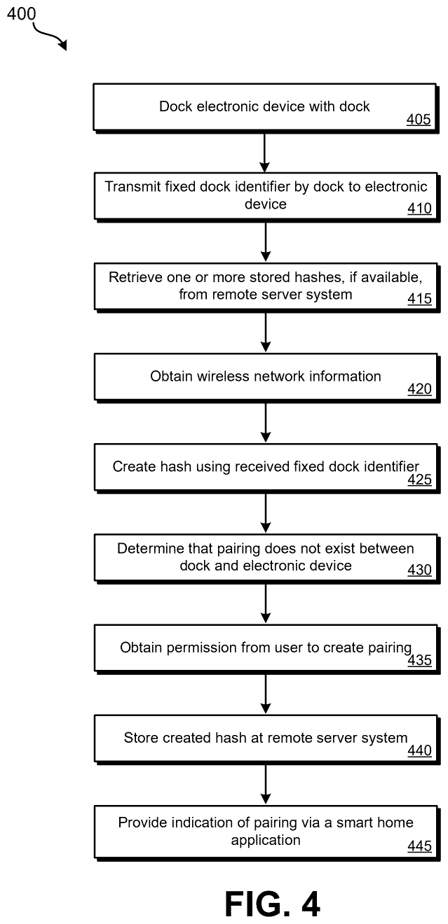

Processing system 223 can include one or more processors, which are used to perform the functionality detailed in relation to the methods of FIGS. 4-6. In some embodiments, processing system 223 includes one or more general-purpose processors that are used to execute software, such as an operating system and applications, installed on electronic device 220. Such general-purpose processors may execute special-purpose software that is stored using one or more non-transitory processor-readable mediums, such as random access memory (RAM), flash memory, a hard disk drive (HDD), or a solid state drive (SSD). Processing system 223 may include one or more special-purpose. Such special-purpose processors may include processors that are specifically designed to perform the functions of the components detailed herein. Such special-purpose processors may be ASICs or FPGAs which are general-purpose components that are physically and electrically configured to perform the functions detailed herein.

Hash storage 225 may be a dedicated non-transitory processor-readable medium used to store one or more hashes. Alternatively, a non-transitory processor-readable medium used for multiple types of data can serve as hash storage 225. Depending on the type of electronic device, various components can be present that allow for a user to interact with electronic device. Such various components can include: display 224, speaker 222, and microphone 227. Display 224, which may be a touchscreen, can allow a user to view various user interfaces and information. Further, if using a touchscreen, a user can touch and interact with elements presented on display 224. Speaker 222 can allow for information to be audibly output, such as spoken messages. Microphone 227 can allow for a user to verbally input commands or questions to electronic device 220. Such components are optional. For example, some electronic devices may have display 224, but no microphone or speaker.

Communication interface 226 allows for communication between electronic device 220 and dock 210. Communication interface 226 may use wired or wireless communication. For example, as previously detailed, a short-range device-to-device communication protocol, such as Bluetooth Classic or Bluetooth LE may be used. Other short-range device-to-device communication protocols can include NFC or WiFi® direct. In some embodiments, communication interface 226 can be incorporated with charging circuitry 228 in order to detect modulation of a charging magnetic field frequency and amplitude, thus allowing data to be received by electronic device 220 via the magnetic field produced during wireless charging by dock 210. In some embodiments, where electrical connections are present between dock 210 and electronic device 220, communication can occur via any proprietary communication protocol or a variety of wired communication protocols.

Electronic device 220 can access network 230 to communicate with server system 240. Network 230 can include one or more private and/or public networks. For example, a private network may be a private wireless local area network and a public network can be the Internet. For example, a possibility may be a WiFi™ network hosted by a wireless router that communicates with the Internet via a modem and internet service provider (ISP).

Server system 240 can include one or more computing systems, which may be distributed or hosted in the cloud. Server system 240 can include: account/hash database 241 and hash manager 242. Server system 240 can make use of one or more processors and non-transitory processor-readable mediums. Account/hash database 241 can be used to store hashes that map a particular electronic device to a particular dock. Each hash stored in account/hash database 241 is mapped to a particular user account. Upon request, the one or more stored hashes stored in association with a particular user account can be transmitted to an electronic device associated with the particular user account.

Hash manager 242 can serve to manage account/hash database 241. Hash manager 242 can be used to add, delete, and transmit hashes stored in association with a user account. For example, via an application on an electronic device (which may or may not be electronic device 220), a user can delete a pairing between electronic device 220 and dock 210. When this pairing is deleted, the associated hash stored in account/hash database 241 is deleted, thus preventing access to one or more restricted features from being accessed via electronic device 220 when electronic device 220 is docked with dock 210.

Since each pairing is between a particular dock and a particular electronic device (e.g., electronic device 220 and dock 210), electronic device 220 can be associated with multiple pairings, each with a different dock. For each of these pairings, a separate hash is maintained in account/hash database 241. Each hash can be managed separately, such as individually deleted, when a user no longer desires a restricted feature be revealed when docked with a particular dock. Since each pairing is distinct, each pairing can be used to reveal different (or the same) restricted features.

Similarly, each dock can have multiple active pairings. While the fixed identifier of the dock does not change, the fixed identifier can be used to create multiple hashes that are mapped to multiple electronic devices (and multiple users). These pairings can be active such that different restricted functions (or the same) of each paired electronic device are made available based on which electronic device is currently docked.

In some embodiments, when electronic device 220 undergoes a reset (e.g., a factory reset to delete all customer data), a locally-stored random or pseudo-random value that is used to create hashes is changed. This change performed as part of a reset being performed at electronic device 220 prevents any restricted feature from being accessed on docking with a dock that was previously paired, even if communication with the server is unavailable. The remote server may continue to store outdated information, but is not made aware of the reset. In some embodiments, a message may be transmitted to server system 240 which results in the associated hashes in account/hash database 241 being deleted. For instance, when network connectivity is available, a message indicative of the reset to delete the stored hashes can be transmitted to server system 240.

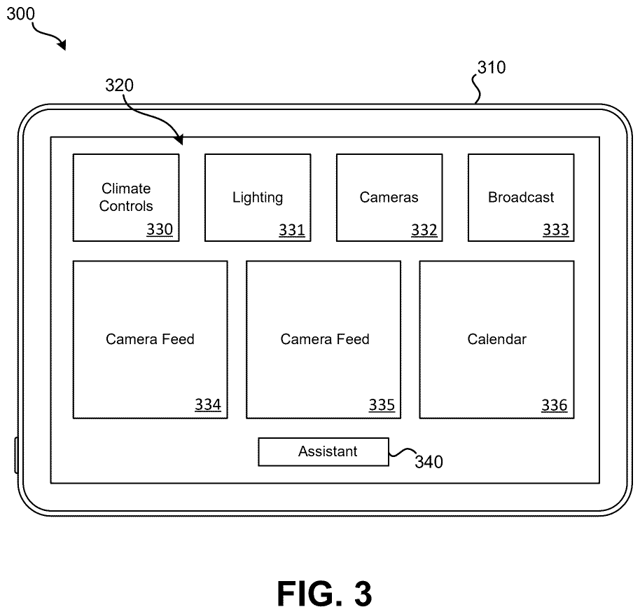

FIG. 3 illustrates an embodiment 300 of a smart home application 320 being executed by tablet computer 310. In embodiment 300, tablet computer 310 is docked with a dock which has previously been paired with tablet computer 310 and an associated hash has been verified. In embodiment 300, while docked, a user interface of smart home application 320 provides access, without additional authentication (e.g., biometrics, password, passcode), to various restricted features, such as: climate controls via climate control graphical element 330 for a structure at which the dock is located; lighting via light graphical element 331 for the structure at which the dock is located; one or more cameras via cameras graphical element 332 which may be inside and/or outside of the structure at which the dock is located; broadcast via broadcast graphical element 333 can permit an audio message to be transmitted and output via other smart devices present at the structure at which the dock is located; camera feed element 334 and camera feed element 335 can present live feeds from cameras that a user has selected for presentation directly in the user interface of smart home application 320. Additionally or alternatively present may be calendar element 336, which may include one or more calendar entries particular to the user. In some embodiments, access to a voice assistant via voice assistant element 340 may be permitted that allows for a spoken command to be received, analyzed, and responded to via smart home application 320 or an operating system of tablet computer 310. The various elements may be continuously presented by a display of tablet computer 310 remaining on while tablet computer 310 is docked with a dock.

Smart home application 320 may provide access to fewer or greater restricted features than as presented in FIG. 3. The arrangement of elements in smart home application 320 is merely exemplary. As another example, while docked and paired, a photo slideshow may be shown of personal photos designated by the user until a user touches the screen of tablet computer 310; once touched, smart home application 320 may be presented.

Various methods may be performed using the systems and devices of FIGS. 1-3. Specifically, methods can be performed to create a pairing, provide access to restricted features while paired, and delete or remove a pairing. To create a pairing between an electronic device and a particular dock, method 400 of FIG. 4 can be performed. FIG. 4 illustrates an embodiment of a method 400 for creating pairing between a dock and electronic device. Method 400 can be performed using docking system 200. For example, when electronic device 220 may be used to perform method 400 a first time that electronic device 220 is docked with dock 210.

At block 405, an electronic device is docked with a dock, establishing a physical or electrical connection to initiate interaction between the two components. This connection may be magnetic. In other embodiments, the electronic device rests on the dock. Charging may be performed via a magnetic field. At block 410, the dock can transmit a fixed dock identifier, such as a dock serial number, to the electronic device. This unique identifier of the dock is permanent, meaning that any reset or reconfiguration of the dock does not result in the fixed dock identifier changing. Different manufacturers may be provided with different ranges of values to use for the fixed dock identifier to ensure that each manufacturer's identifiers differ. In some embodiments, encryption is used, such as via a public/private key pair, to transmit the fixed dock identifier from the dock to the electronic device. Such an arrangement may be particularly beneficial to protect the fixed dock identifier if wireless communication (e.g., Bluetooth or some other short-range device-to-device communication protocol) is used. In some embodiments, modulation of a charging magnetic field frequency and amplitude is performed in order to transmit the fixed dock identifier to the electronic device.

At block 415, in response to docking at block 405 and receiving the fixed dock identifier at block 410, the electronic device can retrieve one or more stored hashes, if available, from a remote server system. These stored hashes, if present, correspond to prior pairings or associations between the electronic device and one or more docks. Alternatively, one or more of the hashes might correspond to the combination of the electronic device and the dock with which the electronic device is presently docked, but some other variable may have changed, such as the wireless network with which the electronic device is currently connected. In some embodiments, one or more stored hashes, if available, can be stored locally by the electronic device.

At block 420, wireless network information is obtained by the electronic device. The wireless network information can include the service set identifier (SSID) and passkey for a wireless with which the electronic device is currently connected. The local wireless network information, such as SSID and passkey, can help prevent a dock from being relocated to another physical location and unintentionally revealing a restricted feature when the electronic device is docked. For example, if the local wireless network information with which the electronic device is paired matches the local wireless network information used to create the hash, there is a strong likelihood that the dock is at the desired location or at least relatively close-by to where a user originally configured a pairing between the dock and the electronic device. In some embodiments, additional or alternative information, for the wireless network can be determined at block 420. Wireless network information can be obtained locally at the electronic device since such information has already been used to connect with the wireless network. Blocks 410, 415, and 420 can be performed in any order.

Using the wireless network information, the retrieved fixed dock identifier, and an identifier of the electronic device, a hash is created by the electronic device at block 425. The identifier of the electronic device may not be fixed. That is, when the electronic device is reset (e.g., a factory reset), the electronic device identifier may change. The device identifier may be specific to the user of the device. That is, the device identifier may be changed if the electronic device is ever reset or otherwise reassigned and associated with a different user or user account Additionally, the hash may be created based on a random or pseudo-random salt value. If a salt value is used, the electronic device can store the salt value for later use in re-creating the hash value when docked with the dock.

At block 430, the electronic device compares the hash created at block 425 with the one or more retrieved stored hashes, if any were present. In this arrangement, no correspondence is determined to be present between the created hash and any stored hash. As such, at this point, no access is given to any restricted feature. The electronic device may be charged, but no access to any restricted feature, without providing additional authentication (e.g., a passcode, biometrics) is provided by the electronic device.

At block 435, the electronic device can provide an interface seeking user permission to create the pairing between the dock and the electronic device. If the user desires to create such as pairing, as part of block 435, the user can be required to provide authentication (e.g., a passcode, biometrics) to the electronic device prove that the user is permitted to create such a pairing with the dock. As part of block 435, the user may define what restricted features are to be made available when the electronic device is docked with the dock in the future. An indication of the particular restricted feature may be stored locally or with the hash by the remote server system remotely. Further, as part of block 435, a list of all the named docks (which can be named based on the room in which they are located) present in the household can be obtained and the user can have the option to associate one of the existing names for docks with the dock. Alternatively, the user can assign the dock a new name. A new device identifier can be created and mapped to the name of the dock at the remote server system. By allowing a user to select a location or name that is already in existence for the dock, the setup process for an electronic device and a dock which has previously been set up be a highly simplified “one-touch” process, such as including selection of the preexisting name and, possibly, providing authorization for the pairing.

At block 440, once permission is granted, the created hash of block 425 is stored at the remote server system in association with the user account. The hash may also be stored locally by the electronic device. Occasionally, the hashes stored locally can be synchronized with the one or more hashes stored remotely by the remote server system. At block 445, in some embodiments, an indication of the pairing between the dock and the electronic device is provided via a smart home application. Via the indication, the user can have the option to delete the pairing or update the associated preferences (e.g., what restricted features are made available when docked with the associated dock). In some embodiments, in addition or in alternate to using a smart home application, the pairing can be deleted or updated via logging in to the user account via a website.

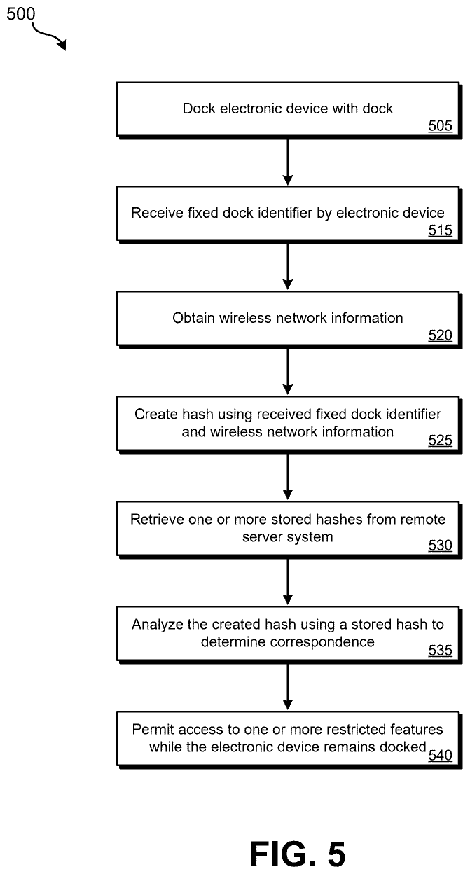

FIG. 5 illustrates an embodiment of a method for authenticating an electronic device to provide access to a restricted feature when docked. Method 500 can be performed using docking system 200. For example, method 500 may be performed sometime an electronic device is docked with a dock after method 400 has been performed for the specific pairing of the electronic device and the dock.

At block 505, the electronic device is docked with a the dock, establishing a wired or wireless connection to initiate interaction between the two devices. This connection may be magnetic. In some embodiments, the electronic device may just rest or be placed on the dock. Charging may be performed immediately, such as via a magnetic field or via a physical electrical connection.

At block 515, the dock transmits a fixed dock identifier, such as a dock serial number, to the electronic device, either via a wired or wireless communication arrangement. This identifier is unique and remains permanent, even after any reset or reconfiguration of the dock. To ensure uniqueness across manufacturers, different identifier ranges may be assigned to various manufacturers. In some embodiments, encryption, such as a public/private key pair, is used to securely transmit the fixed dock identifier to the electronic device, particularly when utilizing wireless communication protocols (e.g., Bluetooth™). Alternatively, modulation of a charging magnetic field frequency and/or amplitude can allow the dock to communicate the fixed dock identifier, in encrypted or unencrypted form, to the electronic device.

At block 520, the electronic device obtains wireless network information for the wireless network with which the electronic is presently communicating. This information can include details such as the SSID and passkey for the wireless network to which it is connected. In some embodiments, alternative or additional information about the wireless network may be determined at this stage. The information is obtained locally by the electronic device, as it has already been used to establish the network connection.

At block 525, the electronic device creates a hash using the received fixed dock identifier, a device identifier, and the wireless network information. As previously detailed the device identifier may not be fixed and may change each time the electronic device is reset (e.g., a factory reset that deletes all user data). In some embodiments, creation of the hash also includes a random or pseudo-random salt value.

At block 530, the electronic device retrieves one or more stored hashes from the remote server system. The one or more stored hashes correspond to at least one previous pairing between the electronic device and the dock, such as performed according to method 400. Alternatively, the one or more stored hashes may be stored and retrieved locally at the electronic device.

At block 535, the electronic device analyzes the created hash by comparing it or otherwise analyzing it in conjunction with the one or more stored hashes retrieved at block 530. This comparison can involve using the salt value that was previously used to create the hash value. This salt value can be stored locally by the electronic device. The comparison can be used to identify an exact numerical match between the stored and generated hash values. If the hashes match, a determination is made that the same: device identifier, wireless network information, and fixed dock identifier are present. If a correspondence is found, the electronic recognizes the pairing between the dock and the electronic device.

At block 540, in response to the correspondence determined at block 535, access is permitted to one or more restricted features while the electronic device remains docked. This access is permitted without any additional passcode or biometrics being needed. Therefore, persons other than the user can make use of the restricted features while the electronic device remains docked. The one or more particular restricted features made available for use or viewing was previously configured, such as by the user as part of method 400 of FIG. 4.

If no correspondence between the created hash and a stored hash is found, the electronic device may still charge, but access to the one or more restricted features may require further authentication, such as via a passcode or biometrics. In some embodiments, the user is notified of the access authorization or denial via a display or audio notification of the electronic device. In other embodiments, the restricted feature is immediately presented for use. The electronic device may remain unlocked and, possibly, have its display activated to allow for convenient access to the one or more restricted features.

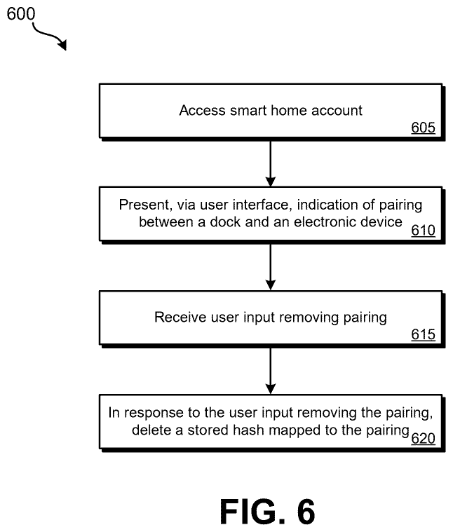

FIG. 6 illustrates an embodiment of a method 600 for removing a pairing between a dock and an electronic device. Method 600 can be performed using docking system 200. For example, method 600 may be performed any time after method 400 (or some other similar method for establishing a pairing) has been performed for the specific pairing of the electronic device and the dock.

At block 605, a user accesses a smart home account. The smart home account can be accessed via a user interface presented on a computing device, such as a smartphone, tablet, or computer. For example, via a smart home application installed and executed on an electronic device, a user interface can be launched that allows for access to information on the user's smart home account. Such information can be retrieved from a remote server system, such as the remote server system used to maintain account/hash database 241. For method 600, the smart home account is associated with one or more electronic devices and docks that have been previously paired.

At block 610, the electronic device presents, via the user interface, an indication of the pairing between a dock and an electronic device. The indication may include details such as the specific dock (e.g., by location or a user-given name) and electronic device involved in the pairing, the date or time the pairing was established, and any associated preferences or restricted features configured for the pairing. This information allows the user to review the status of the pairing and take further action if necessary. The electronic device used to perform block 610 can differ from the electronic device involved in the pairing with the dock.

At block 615, the electronic device receives user input to remove, delete, or rename the pairing between the dock and the electronic device. The user input may be provided through an interactive element, such as a button or menu option, within the user interface. In some embodiments, in response to a user initiating a factory reset of the electronic device involved in the pairing, a message can be transmitted to the remote server system to delete the hash associated with the pairing. In some embodiments, additional authentication may be required, such as a passcode or biometric verification, to confirm the user's authorization to remove the pairing.

In response to a user indicating to delete, remove, or rename the pairing, the user may also receive an option to delete, reset, or rename the pairings that are tied to the same account and associated with a same room name (which are likely associated with the same dock since it is unlikely multiple docks are present within the same room). This option allows the user to delete other pairings of the dock with other electronic devices. This arrangement helps avoid the issue that if a dock is moved to a different room and one electronic device is used to change the name of a pairing or room associated with a dock pairing, other electronic devices may continue to use an old name or room name associated with dock pairings. The user could have the option of renaming all dock pairings associated with a particular room to new names. If a user chooses not to do this, data may be stored on the remote server system such that when the electronic devices associated with each other pairing are docked with the dock in the future, a prompt will be output via the electronic device asking whether the dock pairing or room name should be updated (e.g., by allowing the user to select the new name that was provided, input a new name, or keep the old name).

At block 620, in response to the user input removing the pairing, the remote server system deletes the associated stored hash. The hash, which was previously created to represent the association between the dock and the electronic device, is deleted (or otherwise removed) from the account/hash database and, in some embodiments, from local storage on the electronic device. This deletion ensures that the pairing is no longer recognized and prevents access to any restricted feature from being provided if and when the electronic device is docked with the dock. The user may receive a confirmation, via the user interface, indicating that the pairing has been successfully removed.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A docking system, comprising:
a dock comprising a non-transitory processor-readable medium that stores a dock identifier; and
an electronic device configured to dock with the dock, wherein the electronic device is configured to:
receive the dock identifier from the dock;
obtain wireless network information;
create a hash value based on the dock identifier and the wireless network information;
analyze the hash value using a stored hash to determine to identify a match; and
in response to the match, permitting access to a restricted feature while the electronic device remains docked with the dock.

2. The docking system of claim 1, wherein the dock identifier is permanently associated with the dock.

3. The docking system of claim 1, wherein the electronic device is further configured to:
transmit, to a remote server system, a request for one or more stored hashes mapped to the electronic device; and
in response to the request, receive the one or more stored hashes from the remote server system.

4. The docking system of claim 1, wherein the wireless network information comprises a service set identifier (SSID) and passkey.

5. The docking system of claim 1, wherein the electronic is further configured to create the hash value based on a device identifier indicative of an owner and a salt value.

6. The docking system of claim 1, wherein the electronic device is further configured to:
create an initial hash value using the dock identifier and wireless network information;
obtain user authorization to allow access to the restricted feature while the electronic device remains docked with the dock;
create the stored hash based on the initial hash value; and
transmit the stored hash for storage to a remote server system.

7. The docking system of claim 6, further comprising the remote server system, wherein the remote server system is configured to:
store the stored hash received from the electronic device; and
in response to storing the stored hash, cause an indication of a device pairing between the dock and the electronic device to be presented in an application.

8. The docking system of claim 7, wherein the remote server system is configured to:
receive, from the application, a request to remove the device pairing; and
in response to receiving the request to remove the device pairing, deleting the stored hash.

9. The docking system of claim 7, wherein the remote server system is configured to:
store a plurality of stored hashes, comprising the stored hash, wherein each stored hash is mapped to the electronic device and a different dock.

10. An electronic device, comprising:
a housing;
an electronic display housed by the housing;
a processing system, comprising one or more processors, housed by the housing, wherein the processing system is configured to:
obtain a dock identifier from the dock when the electronic device is docked with the dock for charging the electronic device;
obtain wireless network information;
create a hash value based on the dock identifier and the wireless network information;
analyze the hash value using a stored hash to determine to identify a match; and
in response to the match, permit access to a restricted feature while the electronic device remains docked with the dock.

11. The electronic device of claim 10, wherein the restricted feature provides control of one or more smart home devices.

12. The electronic device of claim 10, wherein the dock identifier is permanently associated with the dock.

13. The electronic device of claim 10, wherein the electronic device is further configured to:
transmit, to a remote server system, a request for one or more stored hashes mapped to the electronic device; and
in response to the request, receive the one or more stored hashes from the remote server system.

14. The electronic device of claim 10, wherein the wireless network information comprises a service set identifier (SSID) and passkey.

15. The electronic device of claim 10, wherein the processing system is further configured to create the hash value based on a device identifier indicative of an owner and a salt value.

16. The electronic device of claim 10, wherein the processing system is further configured to:
create an initial hash value using the dock identifier and wireless network information;
obtain user authorization to allow access to the restricted feature while the electronic device remains docked with the dock;
create the stored hash based on the initial hash value; and
transmit the stored hash for storage to a remote server system.

17. A method for authenticating an electronic device to provide access to a restricted feature, the method comprising:
while docked, receiving, by the electronic device, a dock identifier from the dock, wherein the dock identifier is permanently associated with the dock;
obtaining, by the electronic device, wireless network information;
creating, by the electronic device, a hash value based on the dock identifier and the wireless network information;
analyzing the hash value using a stored hash to determine to identify correspondence between the hash value and the stored hash; and
in response to the hash value and the stored hash being determined to correspond, permitting access to the restricted feature of the electronic device while the electronic device remains docked with the dock.

18. The method of claim 17, wherein creating the hash value is further based on a salt value created locally by the electronic device.

19. The method of claim 18, wherein the restricted feature allows for control of one or more smart home devices.

20. The method of claim 17, further comprising, retrieving, by the electronic device, the stored hash value from a remote server system, wherein the stored hash is stored by the remote server system as mapped to an account associated with the electronic device.
